(19) United States
(12) Patent Application Publication
(10) Pub. No.: US 2026/0221853 A1
(43) Pub. Date: Jul. 30, 2026

(54) STATOR CORE WITH MULTI-DIRECTIONAL MAGNETIC GRAIN

(71) Applicant: BorgWarner Inc., Auburn Hills, MI (US)

(72) Inventor: David A. Fulton, Anderson, IN (US)

(21) Appl. No.: 19/460,989

(22) Filed: Jan. 27, 2026

Related U.S. Application Data
(60) Provisional application No. 63/750,026, filed on Jan. 27, 2025.

(51) Int. Cl. H02K 15/022; H02K 1/14

(52) U.S. Cl. CPC H02K 15/022; H02K 1/14

(57) ABSTRACT

Method aspects of the disclosure provide a method for manufacturing an embodiment of a stator core. The method includes providing flakes that each have a magnetic anisotropy. The method also includes positioning a first portion of the flakes to form the shape of at least one portion of the yoke of the stator, applying a first magnetic field to the flakes of the first portion, and joining each flake of the first portion together to create the yoke. The method also includes positioning a second portion of the flakes to form the shape of at least one portion of the teeth of the stator, applying a second magnetic field to the second portion of the flakes, and joining each flake of the second portion together to create at least one portion of the teeth attached to the yoke, and repeating the preceding steps to complete the stator core.

### CROSS REFERENCE TO RELATED APPLICATIONS

This application claims the benefit of an earlier filing date from U.S. Provisional Application Serial No. 63/750,026 filed Jan. 27, 2025, the entire disclosure of which is incorporated herein by reference.

### BACKGROUND OF THE INVENTION

It is known that electric motors require magnetic flux carrying cores for the stator and rotor assemblies of the motor. The prior art make such cores out of silicon steel sheets, also referred to as laminations, which are punched out to the desired shape. The laminations are then stacked and bonded or welded to form lamination stacks. It is also known that insulated laminations reduce eddy current losses in the steel cores due to time-varying magnetic fields.

The prior art provides that silicon steel laminations are available in two types: (1) non-grain-oriented (NGO) electrical steel, which has similar magnetic properties in any in-plane direction, and (2) grain-oriented (GO) steel, which has superior magnetic properties anisotropically in a single in-plane direction. Specifically, the superior anisotropic directional magnetic properties of GO steel allow the GO steel to have more preferential magnetic properties in one in-plane direction and lesser magnetic properties in its other planar directions that can be comparably worse than the magnetic properties of NGO steel. As such, the electrical motor flux cores of the prior art are generally made from NGO steel because, as known, the major flux paths in the stator cores will be in two directions—radial and circumferential. More specifically, in a stator core, operating flux travels radially in the teeth portions and circumferentially in the back-iron ring or “yoke.”

To leverage the superior anisotropic magnetic properties of GO steel in a stator core over NGO steel, the prior art have proposed creating the teeth of the stator core separate and apart from the yoke out of GO steel and having the teeth then joined to an NGO steel yoke via dovetail joints with the superior anisotropic magnetic direction of the GO steel teeth being directed radially with respect to the fully assembled stator.

However, the prior art has failed to provide a stator core with a yoke and teeth significantly made of anisotropic materials. Also, the prior art has failed to provide a stator core that includes teeth with preferential magnetic properties in the radial direction in combination with a yoke that has preferential magnetic properties in the circumferential direction. Additionally, the prior art has failed to provide for a stator core that is a single monolithic piece that includes teeth having preferential magnetic properties in the radial direction in combination with a yoke that has preferential magnetic properties in the circumferential direction. Moreover, the prior art has also failed to provide for alternatives to insulated lamination stack stator cores that can provide a similar or greater operational efficiency for electromagnetic devices.

### BRIEF DESCRIPTION OF THE INVENTION

Method aspects of the disclosure provide a method for manufacturing an embodiment of a stator core according to the disclosure, the stator core comprising a yoke and teeth. The method includes providing a plurality of flakes. Each flake of the plurality of flakes has a magnetic anisotropy. The method also includes positioning a first portion of the plurality of flakes to form the shape of at least one portion of the yoke. The method further includes applying a first magnetic field to the first portion of plurality of flakes to orient the magnetic anisotropies of the flakes to be substantially aligned with the first magnetic field. The method yet further includes joining each flake of the first portion of the plurality of flakes together to create the at least one portion of the yoke. The method also includes positioning a second portion of the plurality of flakes to form the shape of at least one portion of the teeth within the at least one portion of the yoke. The method further includes applying a second magnetic field to the second portion of the plurality of flakes to orient the magnetic anisotropies of the flakes to be substantially aligned with the second magnetic field. The method yet further includes joining each flake of the second portion of the plurality of flakes together to create the at least one portion of the teeth attached to the at least one portion of the yoke, defining at least one portion of the stator core, and repeating the preceding steps to complete the stator core. The first and second magnetic fields have different magnetic field orientations, and each flake of the plurality of flakes is significantly surrounded by an insulating material.

Method aspects of the disclosure provide a method for manufacturing an embodiment of a stator core according to the disclosure, the stator core comprising a yoke and teeth. The method includes providing a plurality of flakes, with each flake having a respective magnetic anisotropy. The method also includes positioning a first portion of the plurality of flakes to form the shape of yoke, and applying a first magnetic field to the first portion of plurality of flakes to orient the magnetic anisotropy of the flakes to be substantially aligned with the first magnetic field. The method further includes joining each flake of the first portion of the plurality of flakes together to create the yoke. The method yet further includes repeating the following steps until each of the teeth and the stator core is complete: positioning an additional portion of the plurality of flakes within the yoke to form the shape least one of the teeth; applying a second magnetic field to the additional portion of the plurality of flakes to orient the magnetic anisotropy of the flakes to be substantially aligned with the second magnetic field; and joining each flake of the additional portion of the plurality of flakes together to create at least one of the teeth attached to the yoke. The first and second magnetic fields have different magnetic field orientations, and each flake of the plurality of flakes is significantly surrounded by an insulating material.

Embodiments of the disclosure provide a stator core comprising a yoke and teeth. The yoke is shaped as a cylinder having an interior cavity extending therethrough about a central longitudinal axis of the yoke. The teeth are positioned within the interior cavity of the yoke and are connected to the yoke. Each of the teeth are oriented extending towards the central longitudinal axis of the yoke. The yoke and the teeth each comprise a plurality of flakes, with each flake of the plurality of flakes being substantially surrounded by an insulating material. Each flake of the plurality of flakes has a magnetic anisotropy. The magnetic anisotropy of each of the plurality of flakes of the yoke are directed along a first orientation. The magnetic anisotropy of each of the plurality of flakes of the teeth are directed along a second orientation that is significantly different than the first orientation.

### BRIEF DESCRIPTION OF THE DRAWINGS

The following descriptions should not be considered limiting in any way. With reference to the accompanying drawings, like elements are numbered alike:

FIG. 1 is a schematic illustration of a frontal view of a stator core according to an embodiment of the present disclosure, including a yoke with circumferential flux properties and teeth with radial flux properties.

FIG. 2 is a perspective schematic illustration of a frontal-side view of the stator core illustratively shown in FIG. 1.

FIG. 3 is perspective schematic illustration and side elevation view of flakes according to an embodiment of the present disclosure, with the magnetic properties of the flakes illustratively shown.

FIG. 4 is a schematic illustration of the flakes illustratively shown in FIG. 3, shown with the flakes substantially coated with insulating material.

FIG. 5 is a schematic illustration of a frontal view of one or more portions of a yoke according to an embodiment of the present disclosure, shown with the yoke being made out of flakes and having a first magnetic field applied thereto.

FIG. 6 is a schematic illustration of a perspective frontal-side view of the one or more yoke portions illustratively shown in FIG. 5, shown with the flakes of the yoke being joined together.

FIG. 7 is a schematic illustration of a frontal view of the yoke illustratively shown in FIGS. 5 and 6, including teeth being made from flakes and having a second magnetic field applied thereto.

FIG. 8 is schematic illustration of a perspective frontal-side view of the yoke and teeth illustratively shown in FIG. 7, shown with the flakes of each of the teeth being joined together.

FIG. 9a is a schematic illustration of a perspective elevation view of insulating material and flakes used with a shaping apparatus to create a stator core according to an embodiment of the present disclosure.

FIG. 9b is a schematic illustration of a perspective elevation view of insulating material and flakes used with a shaping apparatus to create a stator core according to an embodiment of the present disclosure.

FIGS. 10-15 are simplified flow diagrams illustrating various non-limiting example methodologies that can be implemented to make some embodiments of the disclosure.

FIG. 16 is a schematic illustration of a perspective frontal-side view of a stator core according to an embodiment of the present disclosure being axially compressed.

### DETAILED DESCRIPTION OF THE INVENTION

A detailed description of one or more embodiments of the disclosed apparatus and method are presented herein by way of exemplification and not limitation with reference to the Figures. As known in the art, electric motors operate based on the fundamental principle of electromagnetic induction, where electrical energy is converted into mechanical energy through the use of magnetic fields. A crucial component of electric motors is a stator core, which serves as a stationary part of the motor that plays a role in generating a rotating magnetic field that drives a rotor. The stator core consists of a yoke and teeth, which together form a magnetic circuit that channels flux during operation of the electric motor. When alternating current flows through windings carried by the stator core, the stator windings produce a magnetic field that alternates in polarity to interact with the rotor to create torque and rotation of the rotor. The design and material properties of the stator core have a significant influence on an electric motor’s efficiency and performance.

The yoke of the stator core acts as the backbone of the magnetic circuit, and is intended as a low-reluctance path for magnetic flux. It is commonly constructed as a laminated stack of thin steel sheets to minimize eddy current losses, which would otherwise lead to excessive heat generation and reduced efficiency. These laminations are typically made from silicon steel, which offers high magnetic permeability and low hysteresis loss. The teeth of the stator core extend inward from the yoke and serve as the mounting points for the windings. They concentrate the magnetic flux and direct it toward the rotor air gap, ensuring effective electromagnetic coupling. During operation, magnetic flux flows through the yoke and teeth in a closed loop, alternating with the AC supply frequency, with the magnetic flux flowing through the teeth in a radial direction outwards relative to a central longitudinal axis of the stator core and flows through the yoke in a circumferential direction.

A good stator core should exhibit several preferred characteristics including high magnetic permeability to facilitate flux flow, low core losses to improve efficiency, and mechanical strength to withstand thermal and electromagnetic stresses. Materials known to be commonly used for stator cores as include laminated silicon steel and insulating varnishes or resins. Specifically, non-grain-oriented silicon steel is for both the yoke and the teeth of the stator core.

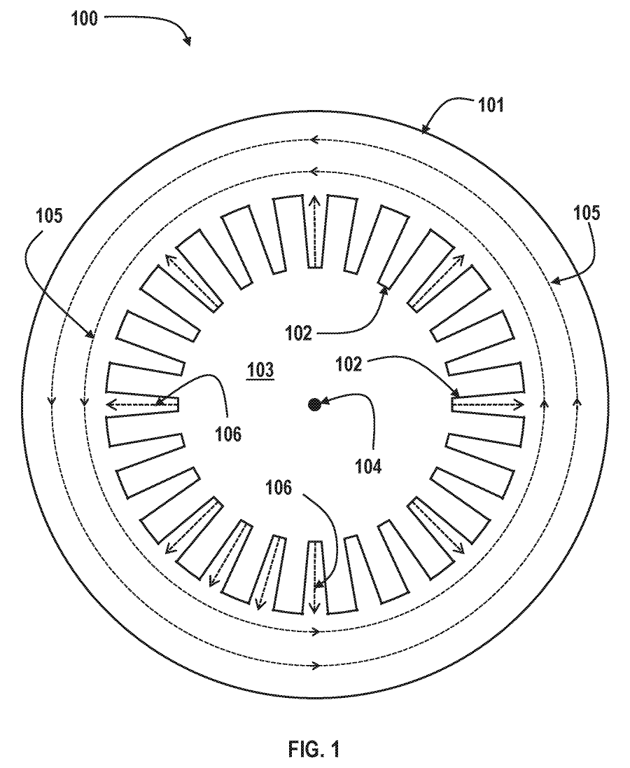

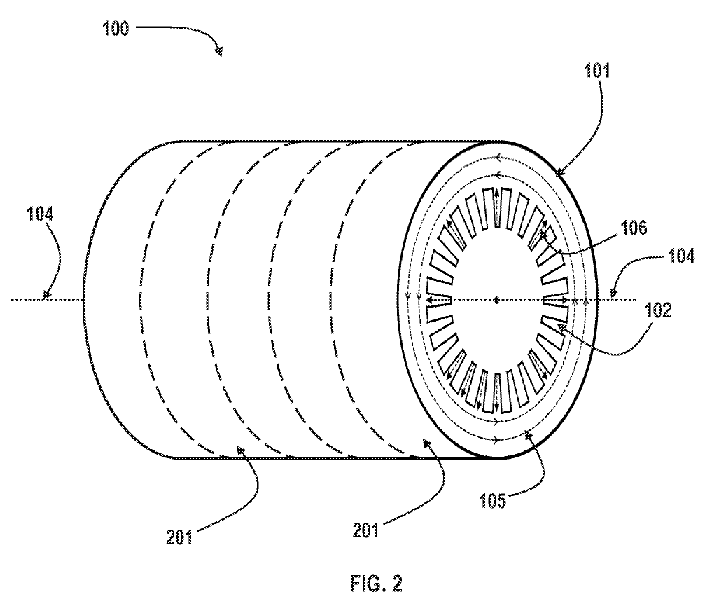

Initially referring to FIGS. 1 and 2, embodiments of the disclosure provide a novel stator core 100 and associated methods thereof for making the stator core 100, which may alternatively and interchangeably be referred to as a “stator core 100” or a “stator 100” throughout the disclosure. The novel stator core 100 has both a yoke 101 and teeth 102 with high permeance, high permeability, and low coercivity characteristics along the predetermined major flux paths 105, 106 of the stator core 100 to thereby increase the effectiveness and efficiency of the operation of an electric motor that uses the stator core 100. Those skilled in the art will notice and appreciate that such novel stator core 100 can significantly increase the efficiency and overall performance of an electrical motor and/or any other similar electromagnetic devices that utilize magnetic cores as compared to the stator cores of the prior art. Throughout the present disclosure, the characteristics of high permeability, high permeance, and low coercivity may be alternatively and interchangeably referred to as “preferred magnetic characteristics” or “preferred directional characteristics” either individually, collectively, and/or in any combination(s) thereof, without any limitation.

The yoke 101 has a substantially cylindrical shape and an interior cavity 103 extending therethrough about a central longitudinal axis 104 of the yoke 101 and/or of the stator core 100. The teeth 102, which may alternatively and interchangeably be referred to as teeth 102 or a tooth 102 throughout the disclosure, are connected to the yoke 101 and positioned within the interior cavity 103. Each of the teeth 102 are oriented significantly extending towards the central longitudinal axis 104 of the stator core 100. Both the yoke 101 and the teeth 102 have high permeability, high permeance, and low coercivity in respective predetermined preferential directions. For example, in some non-limiting embodiments of the disclosure the yoke 101 can have preferential magnetic characteristics in circumferential direction(s) 105 about the yoke 101, and each tooth 102 can have preferential magnetic characteristics in the radial direction 106 and/or in the longitudinal direction 106 of the tooth 102. Those who are skilled in the art will notice and appreciate that having such a yoke 101 and teeth 102 with preferential directional magnetic characteristics can allow an electric motor using the stator 100, or other similar electromagnetic device using the stator core 100, to achieve a greater operational efficiency and overall performance over the stator cores of the prior art.

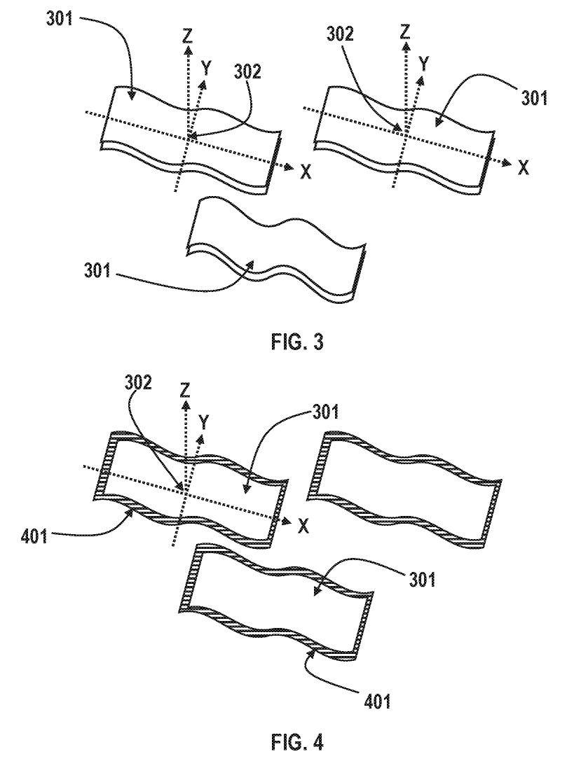

Now also referring to FIGS. 3 and 4, in some example embodiments of the disclosure, the yoke 101 and the teeth 102 of the stator core 100 can comprise material(s) that have anisotropic magnetic characteristics. In some example embodiments of the disclosure, the yoke 101 and the teeth 102 of the stator 100 can comprise magnetically anisotropic material(s) that can comprise flakes and/or insulated flakes, such as the non-limiting example flakes 301 and the non-limiting example insulating material 401 coated flakes 301 illustratively shown in FIGS. 3 and 4. In some example embodiments of the disclosure, the yoke 101 and the teeth 102 of the stator core 100 can comprise high silicon steel (HSS) or HSS flakes. For example, and without limitation, the yoke 101 and the teeth 102 can comprise HSS or insulation coated HSS.

In some embodiments of the disclosure the flakes 301 can have a symmetrical shape and/or the flakes 301 can have an asymmetrical shape. In some embodiments of the disclosure the flakes 301 can have anisotropic magnetic properties such as favorable and/or preferential anisotropic magnetic properties in a single planar direction along the length of the flake 301. For example, each flake 301 can be considered as having the planar directions 302 “X,” “Y,” and “Z.” In some non-limiting example embodiments, each flake 301 can have anisotropic magnetic properties such that each flake 301 can have preferred magnetic properties along one of its planar directions 302. For example, each flake 301 can have preferred anisotropic magnetic properties along its “X” planar directions 302, such that in and/or along the “X” planar directions 302 the flake 301 can have a higher permeability, higher permeance, and lower coercivity than the flake 301 can have in and/or along its “Y” and/or “Z” planar directions 302. For the purposes of the description, it should be known that references to “planar direction(s) 302” of the flake(s) 301 can refer to one or more of the planar directions 302 “X,” “Y,” and “Z,” and references to “anisotropic planar direction 302” of the flake(s) 301, “preferential planar direction 302” of the flake(s) 301, “easy axis” of the flake(s) 301, and/or “magnetic anisotropy” of the flake(s) 301 can refer to the planar direction 302 of the flake which can have preferred anisotropic magnetic properties in and/or along that planar direction 302, without limitation. It is to be understood that for the purposes of the disclosure, the terms “easy axis” and the plural form “easy axes” are referenced with the similar definitions thereof as known in the art to mean the axis and/or one of the axes of an object or material along which magnetic dipoles of the object or material naturally prefer to align in contrast with the other axis and/or axes of the object or material.

In some embodiments of the disclosure, the flakes 301 can be coated in an electrically insulating material 401 and/or dielectric material 401 as can be seen in the non-limiting example flake 301 illustratively shown in FIG. 4. Although the non-limiting example flake 301 illustratively shown in FIG. 3 is shown with the insulating material 401 only surrounding the perimeter of each flake 301, it is to be understood, without limitation, that the insulating material 401 can be surrounding and/or coating the entire surface area and/or substantially the entire surface area of each flake 301. For the purposes of the disclosure, it is to be understood that references to “flake 301,” “flake(s) 301,” and/or “flakes 301” may alternatively and/or interchangeably refer to the flake(s) 301 and/or the flake(s) 301 coated by and/or substantially surrounded by the insulating material 401, without any limitation.

In some non-limiting embodiments of the disclosure, the stator 100 can comprise and/or be made of the flakes 301. For example, without limitation, the stator 100 can entirely and/or substantially comprise and/or be made of flakes 301. For example, the yoke 101 and/or the teeth 102 can entirely and/or substantially comprise and/or be made of flakes 301. Also, in some non-limiting embodiments of the disclosure, the stator 100 can comprise flakes 301 with the flakes 301 oriented to have their preferential planar direction 302 and/or magnetic anisotropy aligned with one another in and/or along one or more predetermined directions. For example, in some non-limiting embodiments of the disclosure, the yoke 101 can comprise flakes 301 with each of the flakes 301 being positioned or oriented such that the flakes 301 magnetic anisotropies are aligned with one another along one or more shared and/or predetermined direction(s), and the teeth 102 can comprise flakes 301 with each of the flakes 301 being positioned or oriented such that the flakes 301 magnetic anisotropies are aligned with one another along one or more shared and/or predetermined direction(s). In some more specific non-limiting embodiments of the disclosure, the yoke 101 can comprise flakes 301 oriented to have their magnetic anisotropies aligned with and/or directed along a circumferential direction 105 of the yoke 101, and each tooth 102 can comprise flakes 301 oriented to have their magnetic anisotropies aligned with and/or directed along a radial direction 106 and/or a longitudinal direction 106 of the tooth 102. It is to be understood that each tooth 102 has a length greater than a width of the tooth 102, and that the teeth 102 extend towards the central longitudinal axis of the assembled stator core 100 by the length of each tooth 102, such that, it should also be understood that terms “radial direction of the teeth/tooth 102” and “longitudinal direction of the teeth/tooth 102” may be used interchangeably and alternatively throughout the disclosure, without limitation. In some non-limiting embodiments of the disclosure, the orientation(s) of the flakes 301 of the yoke 101 can be different than the orientation(s) of the flakes 301 of the teeth 102.

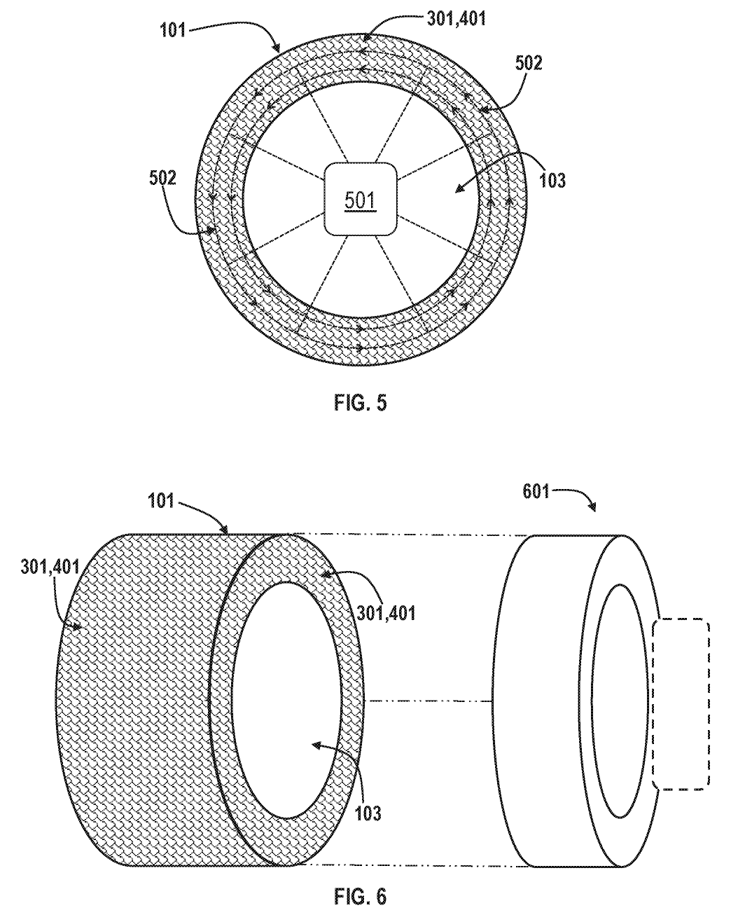

Now referring to FIGS. 5-8, some non-limiting methodologies of creating, making, and/or manufacturing one or more example embodiments of the disclosure will now be described. The flakes 301 can be positioned, molded, assembled, and/or compiled to form the shape one or more portions and/or the entirety of the yoke 101. To ensure that the magnetic anisotropies of the flakes 301, while positioned in the shape of the yoke 101 and/or of the yoke 101 portion(s), are each directed along and/or aligned with one or more direction(s), an orientation process can be performed while and/or after one or more portion(s) of the flakes 301 are and/or are being positioned, molded, assembled, and/or compiled to form the shape of the yoke 101 and/or of the yoke 101 portion(s). For example, in some non-limiting embodiments of the disclosure a magnetic field 502 can be generated and applied to the flakes 301, and/or the flakes 301 can be exposed to and/or acted on by a magnetic field 502, for the magnetic field 502 to induce a magnetic moment and cause a magnetic torque on each flake 301 to cause each flake 301 to move and/or rotate based on the orientation of the magnetic field 502 and the position of the flake 301 within the magnetic field 502. If each flake 301 comprises a magnetically anisotropic material, then each flake 301 can be oriented to align with the magnetic field 502 along the flake’s 301 easy axis and/or magnetic anisotropy. In some non-limiting embodiments of the disclosure, while the flakes 301 are subjected to the magnetic field 502, the flakes 301 can also be subjected to vibration forces to encourage the movement and/or rotation of the flakes 301 due to the magnetic field 502.

The magnetic field 502 can have a predetermined orientation such that the flakes 301 can be oriented in predetermined direction(s) when exposed to the magnetic field 502. For example, and without limitation, the magnetic field 502 can be oriented traveling circumferentially about a central longitudinal axis 104 throughout the shape of the yoke 101 and/or the shape of the yoke portion(s) 101 to cause each flake 301 to be oriented and/or positioned to form the shape of the yoke 101 and/or yoke 101 portion(s) with the easy axes and/or magnetic anisotropies thereof being oriented and/or directed circumferentially 105 about a central longitudinal axis 104 throughout the shaped of the yoke 101 and/or throughout the shape of the yoke portion(s) 101. FIG. 5 illustratively shows a non-limiting example magnetic field generator 501 utilized to generate a magnetic field 502 that travels circumferentially about a central longitudinal axis 104 throughout the shape of the yoke 101. Although the FIGS. of the disclosure illustratively show the flake(s) 301 having a particular dimension and positioned in the shape of the stator 100, yoke 101, and/or teeth 102 in a particular pattern or orientation, it is to be understood that these dimensions, patterns, and orientations of the flakes 301 are shown as illustrative examples that are non-limiting to the disclosure in any way.

While the flake(s) 301 are shaped as the yoke 101 and/or the yoke 101 portion(s), and/or while the magnetic anisotropies of the flakes 301 have been oriented, the flakes 301 can be joined together to hold the shape of and/or create the yoke 101 and/or the portion(s) of the yoke 101. In some non-limiting embodiments of the disclosure the flakes 301 can be joined together by heat treating the flakes 301 and/or by applying a conditioning force to the flakes 301 such as by compression. In some non-limiting embodiments of the disclosure the flakes 301 can be joined together by joining the insulating coatings 401 of the flakes 301 together, which can be by heat treating the insulating coatings 401, by applying a conditioning force to the insulating coatings 401 such as by compression, and/or by curing the insulating coatings 401. In some non-limiting embodiments of the disclosure, the flakes 301 can be joined together after the flakes 301 have been oriented by the magnetic field 502. In some other non-limiting embodiments of the disclosure, the flakes 301 can be joined together while being continually oriented and/or while having their orientations continually maintained by the magnetic field 502.

FIG. 6 illustratively shows a non-limiting example joining device 601 that can be utilized to join the flakes 301 together. It is to be understood that heat treating can include one or more of heating, cooling, hot-pressing, sintering, and/or any combination(s) thereof, without limitation. It also is to be understood that curing can include one or more of temperature curing, infrared curing, ultraviolet light curing, electron-beam curing, gamma radiation curing, chemical curing, environmental curing, vacuum pressure impregnation curing, evaporative curing, and/or any combination(s) thereof, without limitation.

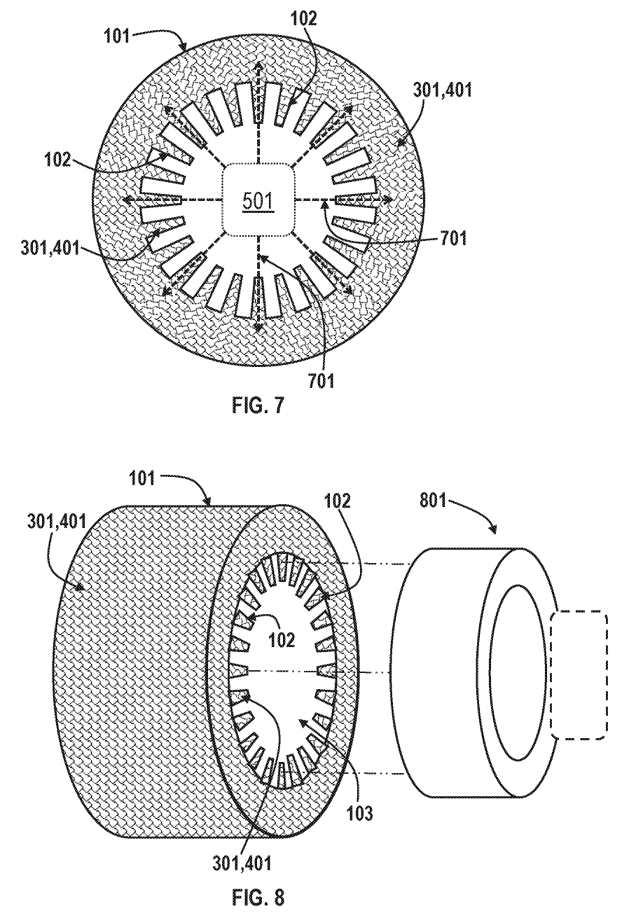

Continuing to refer to FIGS. 7 and 8, the flakes 301 can be positioned, molded, assembled, and/or compiled to form the shape one or more portions and/or one or more of the teeth 102. In some non-limiting embodiments of the disclosure, the flakes can be positioned, molded, assembled, and/or compiled to form the shape of one or more of the teeth 102 and/or portions thereof within the interior cavity 103 of the yoke 101 and/or yoke 101 portion(s). To ensure that the magnetic anisotropies of the flakes 301, while positioned in the shape of one or more of the teeth 102 and/or portions thereof, are each directed along and/or aligned with one or more direction(s), an orientation process can be performed while and/or after one or more portion(s) of the flakes 301 are and/or are being positioned, molded, assembled, and/or compiled to form the shape of one or more of the teeth 102 and/or portions thereof. For example, in some non-limiting embodiments of the disclosure a magnetic field 701 can be generated and applied to the flakes 301, and/or the flakes 301 can be exposed to and/or acted on by a magnetic field 701. The magnetic field 701 can induce a magnetic moment and cause a magnetic torque on each flake 301 to cause each flake 301 to move and/or rotate based on the orientation of the magnetic field 701 and the position of the flake 301 within the magnetic field 701. If each flake 301 comprises a magnetically anisotropic material, then each flake 301 can be oriented to align with the magnetic field 701 along the flake’s 301 easy axis and/or magnetic anisotropy. In some non-limiting embodiments of the disclosure, while the flakes 301 are subjected to the magnetic field 701, the flakes 301 can also be subjected to vibration forces to encourage the movement and/or rotation of the flakes 301 due to the magnetic field 701.

The magnetic field 701 can have a predetermined orientation such that the flakes 301 positioned in the shape of one or more of the teeth 102 and/or teeth portion(s) 102 can be oriented in predetermined direction(s) when exposed to the magnetic field 701. For example, and without limitation, the magnetic field 701 can be oriented traveling longitudinally along and through each tooth 102 and/or each tooth 102 portion(s) shaped by the flakes 301 101 to cause each flake 301 to be oriented and/or positioned with the easy axes and/or magnetic anisotropies thereof to be oriented and/or directed aligned with and/or substantially aligned in parallel with the longitudinal axis of the tooth 102 and/or tooth 102 portion(s). FIG. 7 illustratively shows a non-limiting example magnetic field generator 501 utilized to generate a magnetic field 701 that travels longitudinally along and through each tooth 102 and/or each tooth 102 portion(s) shaped by the flakes 301.

While the flake(s) 301 are shaped as one or more of the teeth 102 and/or teeth portion(s) 102 and/or while the magnetic anisotropies of the flakes 301 are in the predetermined orientation, the flakes 301 can be joined together to hold the shape of and/or create the one or more teeth 102 and/or teeth 102 portion(s). The flakes 301 can be joined together via one or more of the aforementioned flake 301 joining methodologies discussed herein. In some non-limiting embodiments of the disclosure, the flakes 301 can be joined together after the flakes 301 have been oriented by the magnetic field 701. In some other non-limiting embodiments of the disclosure, the flakes 301 can be joined together while being continually oriented and/or while having their orientations continually maintained by the magnetic field 701.

In some non-limiting embodiments of the disclosure, joining the flakes 301 shaped as the teeth 102 and/or shaped as the teeth 102 portion(s) together can also join and/or attach the flakes 301 to one or more interior portion(s) of the yoke 101 and/or of the yoke 101 portion(s). Therefore, in some non-limiting embodiments of the disclosure, joining of the flakes 301 shaped as the teeth 102 and/or shaped as the portion(s) of the teeth 102 can result in the connection and joining of the one or more created teeth 102 to the yoke 101 and/or to the yoke 101 portion as a single monolithic unit, which may be referred to as a completed stator 100 and/or as a completed portion 201 of the stator 100. In some non-limiting embodiments of the disclosure, multiple completed portions 201 of the stator 100 can be joined together to create and form the completed stator 100.

In some non-limiting embodiments of the disclosure, joining and/or connecting teeth 102 to the yoke 101 and/or to a yoke 101 portion can be performed after the teeth 102 have been created by the joining of the flakes 301 shaped thereas. FIG. 8 illustratively shows a non-limiting example joining device 801 that can be utilized to join the flakes 301 together to hold the shape of and/or create the one or more teeth 102 and/or to join and/or attach the one or more shaped/created teeth 102 to the created yoke 101 and/or to the created yoke 101 portion(s). It is to be understood that while the teeth 102 are joined to, connected to, and/or attached to the yoke 101 and/or to the yoke 101 portion(s), the magnetic anisotropies of the flakes 301 of each of the teeth 102 can be alternatively and/or interchangeably be referred to as being aligned radially with respect to and/or relative to the central longitudinal axis 104 of the yoke 101 and/or of the yoke 101 portion(s), without limitation.

In some non-limiting methodologies of the disclosure, the steps of positioning, molding, assembling, and/or compiling the flakes to form the shape one or more portions of the yoke 101 and the teeth 102 can be performed substantially concurrently, consecutively, in alternation, and/or in any combination(s) thereof. Therefore, in some non-limiting embodiments of the disclosure, one or more portions of both the yoke 101 and the teeth 102 can be shaped out of flakes 301 prior to any joining of the flakes 301. In such non-limiting example methodologies of the disclosure, the steps of orienting the flakes 301 shaped as the yoke 101 / yoke 101 portion(s) and the joining of said flakes 301, can be performed prior to or after the steps of orienting and joining of the flakes 301 shaped as the one or more teeth 102 within the yoke 101 / yoke 101 portion(s). However, without limitation, it is also contemplated that orienting and joining of the flakes 301 shaped as the yoke 101 portion(s) and of the flakes 301 shaped as the teeth 102 portion(s) can be performed at substantially the same time, however, the magnetic fields 502, 701 will have to be maintained separate from each other and/or maintained such that both predetermined field shapes of the magnetic fields 502, 701 can be maintained despite each other’s concurrent presence and/or such that a combination of both predetermined field shapes can be maintained concurrently.

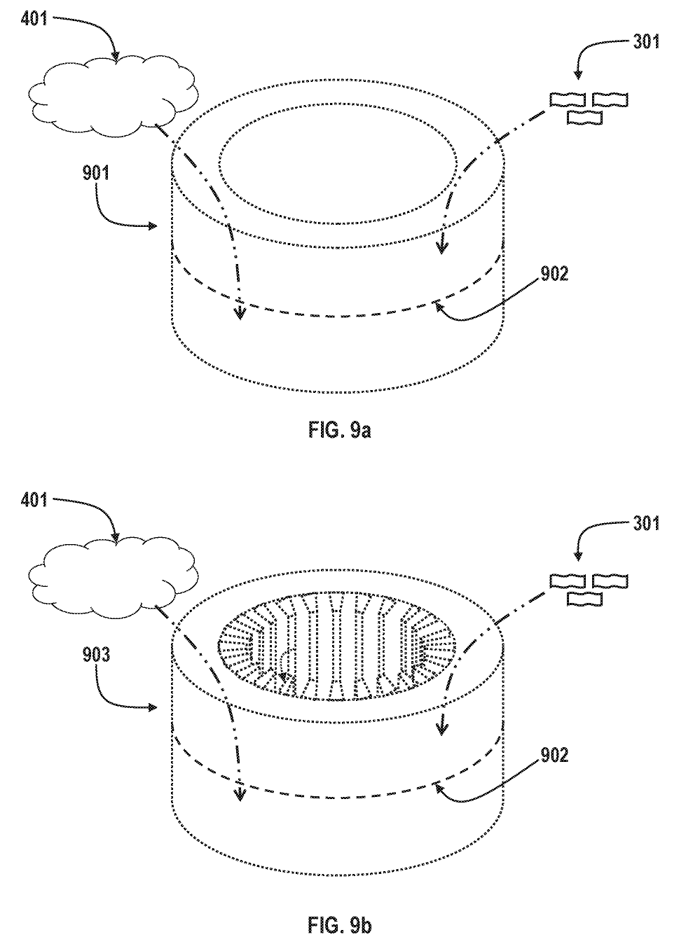

Now referring to FIG. 9a and 9b, a non-limiting example embodiments and methodologies of the disclosure is shown wherein a shaping apparatus 901, 903 can be utilized to form flakes 301 into the shape one or more portions of the yoke 101 and/or one or more portions of the teeth 102. For the purposes of the disclosure, although the shaping apparatus 901 is illustratively shown in FIG. 9a as comprising the shape of only a portion of the yoke 101, and although the shaping apparatus 903 is illustratively shown in FIG. 9b as comprising the shape of only a portion of the yoke 101 and teeth 102 of a stator 100, it is to be understood that in some nonlimiting embodiments the shaping apparatus 901 can also and/or instead comprise the shape(s) of one or more of the teeth 102 separate and apart from the yoke 101, and/or in some nonlimiting embodiments the shaping apparatus 901 can comprise the entire yoke 101 and teeth 102 together to form the shape of the entire stator 100. The shaping apparatus 901, 903 can be utilized as a mold and/or vessel to receive and/or to carry flakes 301 deposited therein and to conform the flakes 301 into the shape of portion(s) of the yoke 101 and/or into the shape of portion(s) of the teeth 102.

In some non-limiting embodiments and method aspects of the disclosure, the flakes 301 and the insulating material 401 can be provided and deposited into the shaping apparatus 901, 903 in turn(s), such as, the exemplary embodiment shown illustrated in FIGS. 9a and 9b. For example, in some nonlimiting embodiments of the disclosure, the insulating material 401 can be substantially fluidic and can be deposited into the shaping apparatus 901, 903 prior to depositing the non-insulted flakes 301 into the shaping apparatus 901, 903. Moreover, without limitation, the insulating material 401 can be deposited into the shaping apparatus 901, 903 to fill and conform to one or more portions of the interior volume of the shaping apparatus 901, 903. Also, in some embodiments and methodologies of the disclosure, the insulating material 401 can be deposited into the shaping apparatus 901, 903 up to a predetermined level 902 and/or up to a predetermined interior volume 902 of the shaping apparatus 901, 903. The predetermined level/volume 902 can be based on a determination of the amount of flakes 301 needed to create the shape of the portion(s) of the yoke 101 and/or of the portion(s) of the teeth 102 to be molded by at least a portion of the shaping apparatus 901, 903, and can be based on a determination of the amount of insulating material 401 needed to satisfactorily coat and/or substantially surround each of the flakes 301 needed to create the portion(s) of the yoke 101 and/or of the portion(s) of the teeth 102 to be molded by at least one portion of the shaping apparatus 901, 903. However, without limitation, it is contemplated that in some non-limiting embodiments and method aspects of the disclosure that the amount of insulating material 401 and/or flakes 301 to be deposited into the shaping apparatus 901, 903 can be estimated with any excess being discarded or recycled as necessary.

In some non-limiting embodiments and methodologies of the disclosure, the shaping apparatus 901, 903 and/or the insulating material 401 carried by the shaping apparatus 901 can be subjected to vibration forces to minimize air pockets, gaps, or bubbles within the deposited insulating material 401. While the insulating material 401 is being carried by the shaping apparatus 901, 903, the flakes 301 can be introduced and/or deposited into the shaping apparatus 901, 903 to fill the remaining interior volume of the shaping apparatus 901, 903 and to become coated by and/or to be submerged by the prior-deposited fluidic insulating material 401. In some non-limiting embodiments and methodologies of the disclosure, the shaping apparatus 901, 903 along with the insulating material 401 and flakes 301 carried by the shaping apparatus 901, 903 can be subjected to vibration forces to encourage mixing and coating of the flakes 301 with the insulating material 401, to minimize air pockets, gaps, or bubbles therebetween, and to encourage the coated flakes 301 to conform to the interior volume portion(s) of the shaping apparatus 901, 903. Thereafter, without limitation, the flakes 301 can be oriented and joined together the same as and/or similar to one or more of the non-limiting example embodiments and/or example methodologies disclosed herein.

Now referring specifically to FIG. 9b, in some non-limiting example embodiments and methodologies of the disclosure, the shaping apparatus 903 can comprise a mold in the shape of one or more portion(s) of, and/or the entire full shapes of both the yoke 101 and the teeth 102 of a stator 100. In these nonlimiting embodiments, the shaping apparatus 903 can be utilized to receive and/or to carry flakes 301 deposited therein and to conform the flakes 301 into shape to form the shape of portion(s) of the yoke 101 and the teeth 102 concurrently.

For example, without limitation, the flakes 301 can comprise coatings of insulation material 401 as described herein, and the coated flakes 301 can be deposited into the shaping apparatus 903 to be molded into / to form the shapes of both the yoke 101 and the teeth 102 by the shaping apparatus 903. In this exemplary embodiment, both the flakes 301 shaping the yoke 101 and the flakes 301 shaping the teeth 102 within the shaping apparatus 903 can be exposed to and/or acted on by a magnetic field, such as magnetic field 502 described herein, to cause each flake 301 to be oriented with the easy axes and/or magnetic anisotropies thereof being oriented and/or directed circumferentially 105 about a central longitudinal axis 104. In this exemplary embodiment, while and/or after the flakes 301 are exposed to the magnetic field 502, the flakes 301 that are forming the shape of the yoke 101 can be joined together to hold the shape of and/or create the yoke 101 the same as and/or similar to the joining of one or more of the nonlimiting embodiments described herein, without joining the flakes 301 that are forming the shape of the teeth 102. Thereafter, in this non-limiting exemplary embodiment, the flakes 301 within the shaping apparatus 903 can be exposed to and/or acted on by another magnetic field, such as magnetic field 701 described herein, to cause the flakes 301 within the shaping apparatus 903 that are non-joined (e.g., the flakes 301 forming the shape of the teeth 102 by the shaping apparatus 903) to be oriented / moved / rotated to cause the easy axes and/or magnetic anisotropies thereof to be aligned with and/or directed along a radial direction 106. In this exemplary embodiment, while and/or after the flakes 301 are exposed to the magnetic field 701, the flakes 301 that are forming the shape of the teeth 102 can be joined together to hold the shape of and/or create the teeth 102 attached to the yoke 101 the same as and/or similar to the joining of one or more of the nonlimiting embodiments described herein, to create the stator 101.

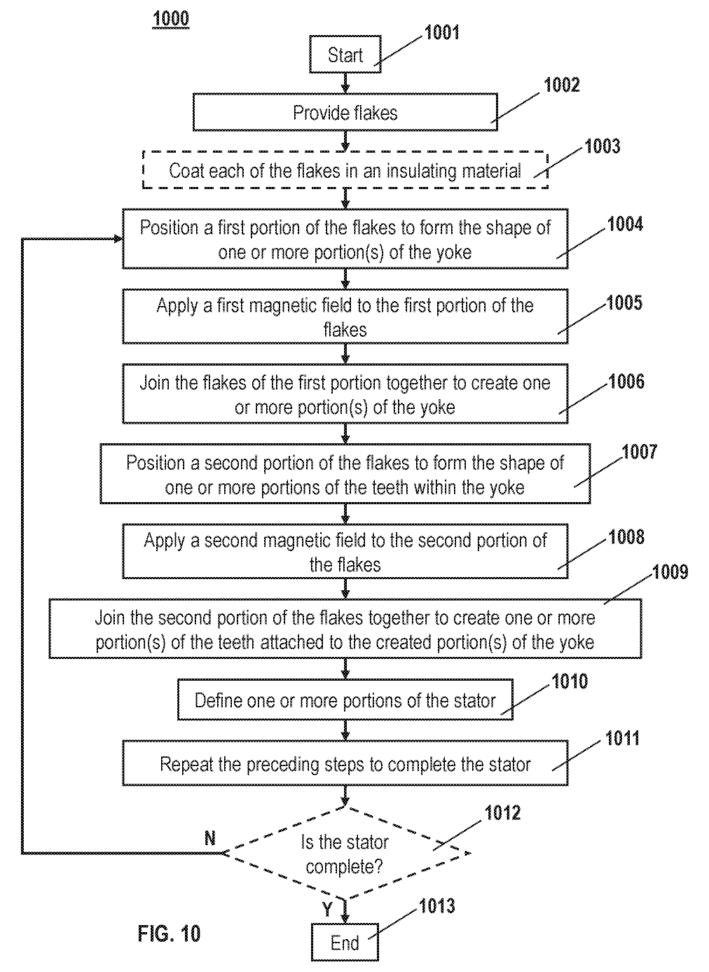

Now referring to FIG. 10, a non-limiting example method 1000 aspect of creating, making, and/or manufacturing a non-limiting example embodiment of the disclosure is illustratively shown as a flowchart diagram. The method 1000 starts at Block 1001 and can move to Block 1002 to provide flakes 301. At Block 1002 the method 1000 can move to Block 1004 to position a first portion of the flakes 301 to form the shape of one or more portion(s) of the yoke 101. In some non-limiting example method aspects of some non-limiting example embodiments of the disclosure, at Block 1002 the method 1000 can move to Block 1003 to coat each of the flakes 301 with an insulating material 401. At Block 1003, the method 1000 can move to Block 1004 to position a first portion of the flakes 301 to form the shape of one or more portion(s) of the yoke 101. From Block 1004, the method 1000 can move to Block 1005 to apply a first magnetic field 502 to the first portion of the flakes 301.

From Block 1005, the method 1000 can move to Block 1006 to join the flakes 301 of the first portion together to create one or more portion(s) of the yoke 101. From Block 1006, the method 1000 can move to Block 1007 to position a second portion of the flakes 301 to form the shape of one or more portion(s) of the teeth 102 within the yoke 101. At Block 1007, the method 1000 can move to Block 1008 to apply a second magnetic field 701 to the flakes 301 of the second portion. From Block 1008, the method 1000 can move to Block 1009 to join the flakes 301 of the second portion together to create one or more portion(s) of the teeth 102 attached to the created portion(s) of the yoke 101. From Block 1009, the method 1000 can move to Block 1010 to define one or more portion(s) of the stator 100 with the created portion(s) of the teeth 102 and yoke 101. From Block 1010 the method 1000 can move to Block 1011 to repeat the preceding steps to complete the stator 100.

In some non-limiting method aspects of the disclosure, at Block 1011 the method 1000 can move to Block 1012 to determine if the stator 100 is complete. If it is determined at Block 1012 that the stator 100 is not complete, then the method 1000 can move to Block 1004 to continue the method 1000. If, however, it is determined at Block 1012 that the stator 100 is complete, then the method 1000 can move to Block 1013 to end the method 1000.

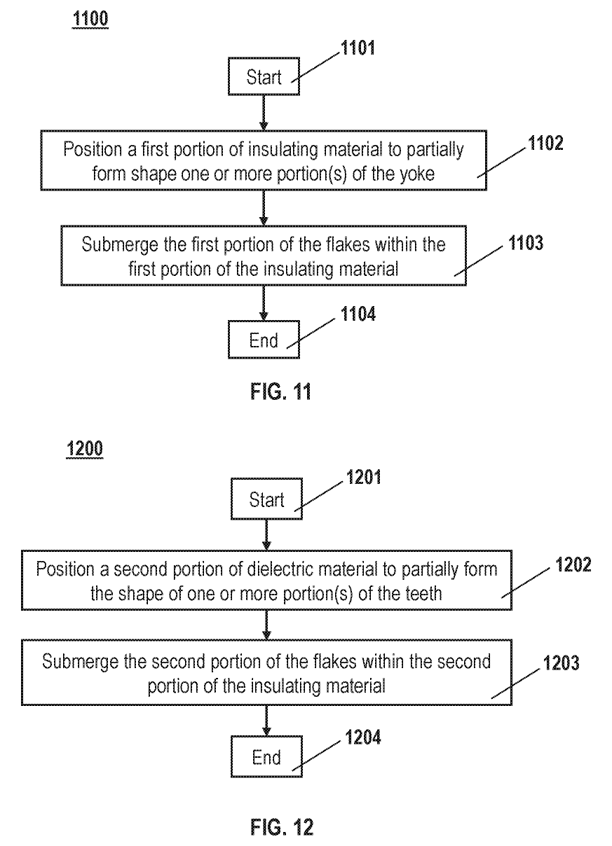

Now referring to FIG. 11, a non-limiting example method 1100 aspect of creating, making, and/or manufacturing a non-limiting example embodiment of the disclosure is illustratively shown as a flowchart diagram. It is contemplated, without limitation, that method 1100 can be included in method 1000 disclosed herein. The method 1100 can start at Block 1101. From Block 1101 the method 1100 can move to Block 1102 to position a first portion of insulating material 401 to partially form the shape of one or more portion(s) of the yoke 101. From Block 1102, the method 1100 can move to Block 1103 to submerge the first portion of the flakes 301 within the first portion of the insulating material 401. From Block 1103 the method 1100 can move to Block 1104 to end the method 1100.

Now referring to FIG. 12, a non-limiting example method 1200 aspect of creating, making, and/or manufacturing a non-limiting example embodiment of the disclosure is illustratively shown as a flowchart diagram. It is contemplated, without limitation, that method 1200 can be included in method 1000 disclosed herein. It is also contemplated, without limitation, that method 1200 can be a continuation of method 1100 disclosed above. The method 1200 can start at Block 1201, and from Block 1201 the method 1200 can move to Block 1202. At Block 1202 the method 1200 can include positioning a second portion of insulating material 401 to partially form the shape of one or more portion(s) of the teeth 102. From Block 1202, the method 1200 can move to Block 1203 to submerge a second portion of the flakes 301 within the second portion of the insulating material 401. From Block 1203, the method 1200 can move to Block 1204 to end the method 1200.

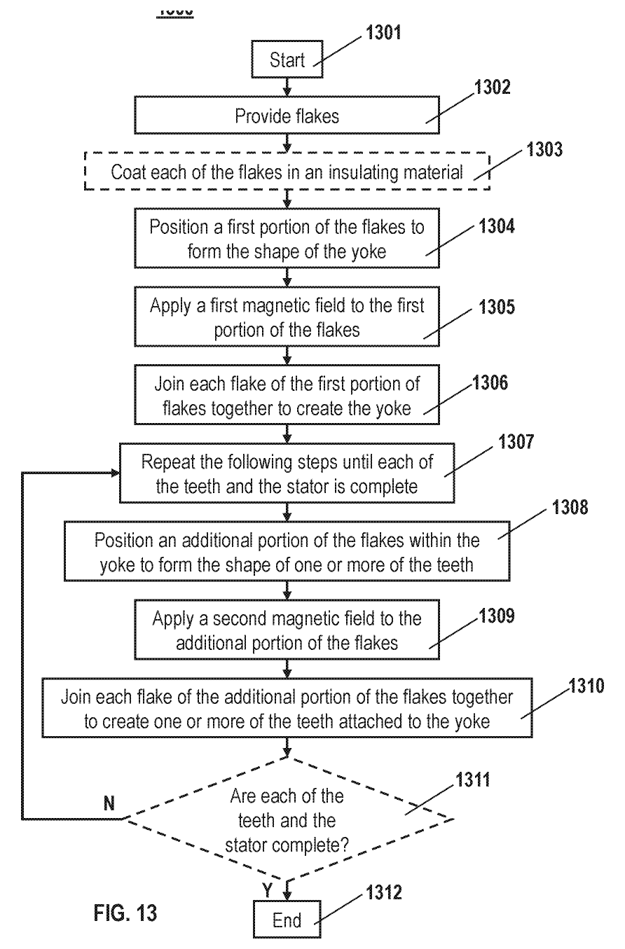

Now referring to FIG. 13, a non-limiting example method 1300 aspect of creating, making, and/or manufacturing a non-limiting example embodiment of the disclosure is illustratively shown as a flowchart diagram. The method 1300 can start at Block 1301, and from Block 1301 the method 1300 can move to Block 1302 to provide flakes 301. In some non-limiting method aspects of the disclosure, the method 1300 can include Block 1303, and from Block 1302 the method 1300 can move to Block 1303 to coat each of the flakes 301 with an insulating material 401. From Block 1303 the method 1300 can move to Block 1304. In some non-limiting method aspects of the disclosure, the method 1300 can include moving directly from Block 1302 to Block 1304. At Block 1304 the method 1300 can include positioning a first portion of the flakes 301 to form the shape of the yoke 101.

From Block 1304 the method 1300 can move to Block 1305 to apply a first magnetic field 502 to the flakes 301 of the first portion. At Block 1305 the method 1300 can move to Block 1306 to join each flake 301 of the first portion together to create the yoke 101. From Block 1306, the method 1300 can move to Block 1307 to repeat the following steps (illustratively shown as Blocks 1308-1310 in FIG. 13) until each of the teeth 102 and the stator 100 are completed. From Block 1307 the method 1300 can move to Block 1308 to position an additional portion of flakes 301 within the yoke 101 to form the shape of one or more of the teeth 102. From Block 1308 the method 1300 can move to Block 1309 to apply a second magnetic field 701 to the additional portion of flakes 301. From Block 1309 the method 1300 can continue to Block 1310 to join each flake 301 of the additional portion of flakes 301 together to create one or more of the teeth 102 attached to the yoke 101.

In some non-limiting method aspects of the disclosure, the method 1300 can include Block 1311. From Block 1310 the method 1300 can move to Block 1311 to determine if each of the teeth 102 and the stator 100 are complete. If, at Block 1311, it is determined that each of the teeth 102 and/or the stator 100 are not completed, then the method 1300 can move from Block 1311 to Block 1307 to continue the method 1300. If, however, at Block 1311 it is determined that each of the teeth 102 and the stator 100 are complete, then the method 1300 can move to Block 1312 to end the method 1300.

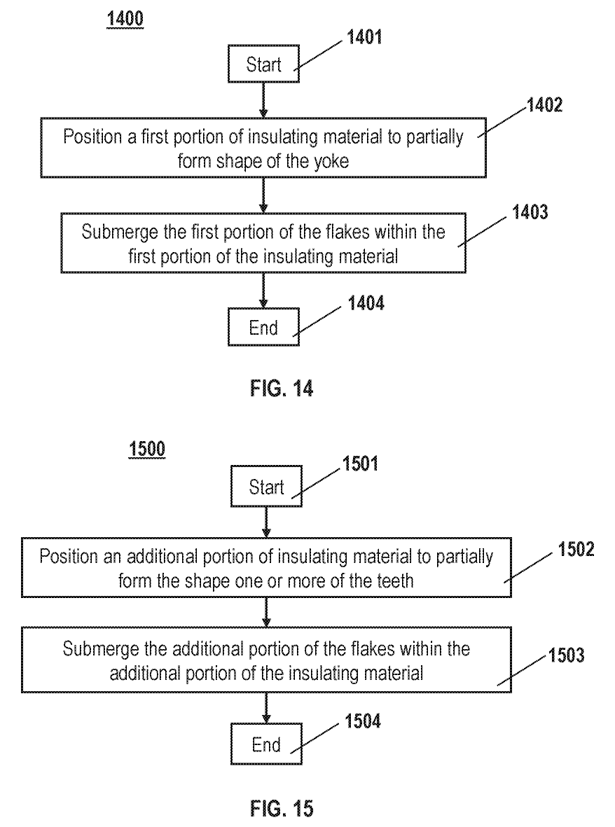

Now referring to FIG. 14, a non-limiting example method 1400 aspect of creating, making, and/or manufacturing a non-limiting example embodiment of the disclosure is illustratively shown as a flowchart diagram. It is contemplated, without limitation, that method 1400 can be included in method 1300 disclosed herein. The method 1400 can start at Block 1401. From Block 1401 the method 1400 can move to Block 1402 to position a first portion of insulating material 401 to partially form the of the yoke 101. From Block 1402, the method 1400 can move to Block 1403 to submerge the first portion of the flakes 301 within the first portion of the insulating material 401. From Block 1403 the method 1400 can move to Block 1404 to end the method 1400.

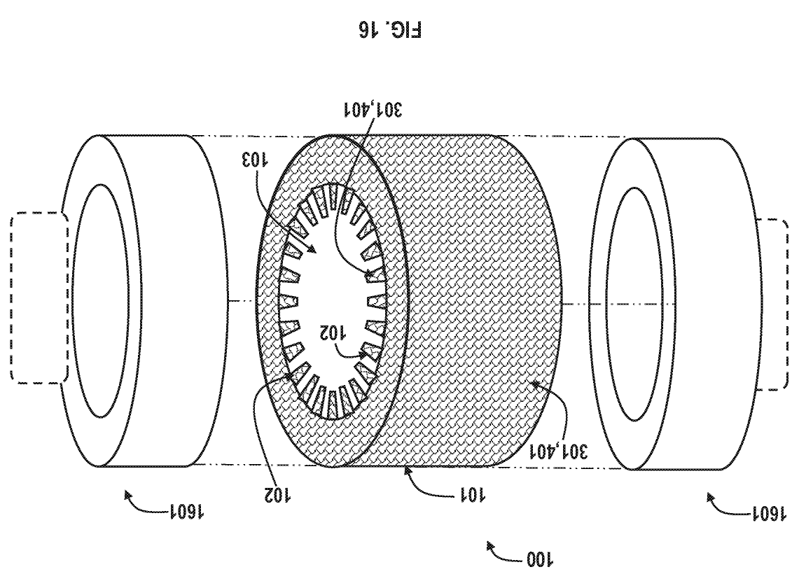

Now referring to FIG. 15, a non-limiting example method 1500 aspect of creating, making, and/or manufacturing a non-limiting example embodiment of the disclosure is illustratively shown as a flowchart diagram. It is contemplated, without limitation, that method 1500 can be included in method 1300 disclosed herein. It is also contemplated, without limitation, that method 1500 can be a continuation of method 1400 disclosed above. The method 1500 can start at Block 1501, and from Block 1501 the method 1500 can move to Block 1502. At Block 1502 the method 1500 can include positioning an additional portion of insulating material 401 to partially form the shape of one or more of the teeth 102. From Block 1502, the method 1500 can move to Block 1503 to submerge an additional portion of the flakes 301 within the additional portion of the insulating material 401. From Block 1503, the method 1500 can move to Block 1504 to end the method 1500.

Now referring to FIG. 16, in some embodiments and methodologies of the disclosure, a compaction process can be performed for densification of a stator 100 formed out of joined flakes 301. For example, without limitation, one or more nonlimiting example compaction units 1601 can be utilized to apply a compression force on the entire stator 100 along the axial direction of the stator 100. This compression force can result in the compaction of the stator 100 and the flakes 301 of the stator 100 to cause an increase in density of the overall stator 100. By increasing the density of the stator 100, without limitation, the maximum flux density capacity of the stator 100 may be increased as compared to the maximum flux density capacity of the stator 100 prior to compaction thereof.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. It is to be understood, that the terms “about”, “substantially”, “significantly”, and “generally” are intended to include the degree of error associated with measurement of the particular quantity based upon the equipment available at the time of filing the application. For example, “about” and/or “substantially” and/or “generally” includes a range of ± 8% of a given value. It is also to be understood, that the terms “about”, “substantially”, “significantly”, and “generally” are intended to include a tolerable range of acceptance associated with the particular quality, trait, characteristic, attribute, function, or element such that embodiments thereof or method aspects thereof are not strictly required to be an absolute perfect replication of the particular quality, trait, characteristic, attribute, function, or element described. For example, “an element having a length and width being substantially oriented longitudinally along a horizontal axis” includes that the element can be oriented longitudinally along the horizontal axis between a tolerable range of acceptance of being along ± 45° off of the horizontal axis. Also, for example, “an element being substantially surrounded by a coating” includes that at least 95% of the element is surrounded by the coating.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A method for manufacturing a stator core that comprises a yoke and teeth, the method comprising:
positioning a plurality of flakes to form the shape of at least one portion of the stator core, with at least a portion of the first plurality of flakes being magnetically anisotropic and having an easy axis;
applying a first magnetic field to the plurality of flakes to orient at least a portion of the flakes to cause the easy axes thereof to be substantially aligned with the first magnetic field to create an aligned portion;
joining at least a portion of the aligned portion of the plurality of flakes together to create fixed flakes in the at least one portion of the stator core;
applying a second magnetic field to the plurality of flakes to orient at least a portion of the flakes to cause the easy axes thereof to be substantially aligned with the second magnetic field;
joining at least a second portion of the plurality of flakes aligned by the second magnetic field together to create another portion of the stator core attached to the at least one portion of the stator core.

2. The method of claim 1, wherein the first and second magnetic fields have different magnetic field orientations.

3. The method of claim 1,wherein the first and second pluralities of flakes are significantly surrounded by an insulating material.

4. The method of claim 1, further comprising positioning a second plurality of flakes to form at least another portion of the stator core, with at least a portion of the second plurality of flakes being magnetically anisotropic and having an easy axis.

5. The method of claim 1, further comprising compressing the completed stator core along axial directions of the stator core.

6. The method of claim 1, wherein applying the first magnetic field to the plurality of flakes to orient at least a portion of the flakes causes the easy axes thereof to be directed substantially circumferentially about a central longitudinal axis of the at least one portion of the stator shaped by the flakes.

7. The method of claim 1, wherein applying the second magnetic field to the plurality of flakes to orient at least a portion of the flakes causes the easy axes thereof to be directed substantially radially with respect to a central longitudinal axis of the at least one portion of the stator core.

8. The method of claim 1, wherein the plurality of flakes are significantly surrounded by the insulating material by coating the plurality of flakes with the insulating material.

9. The method of claim 1, further comprising positioning a first portion of the insulating material to partially form the shape of at least one portion of the stator core; wherein positioning the plurality of flakes to form the shape of the at least one portion of the stator core further comprises submerging the plurality of flakes within the first portion of the insulating material.

10. The method of claim 1, wherein joining the plurality of flakes together comprises at least one of heat treating the plurality of flakes, applying a conditioning force to plurality of flakes, heat treating the insulating material that is significantly surrounding the plurality of flakes, applying a conditioning force to the insulating material that is significantly surrounding the plurality of flakes, and curing the insulating material that is significantly surrounding the plurality of flakes.

11. A method for manufacturing a stator core that comprises a yoke and teeth, the method comprising:
positioning a first plurality of flakes to form the shape of the yoke, at least a portion of the first plurality of flakes being magnetically anisotropic and having an easy axis;
applying a first magnetic field to the first plurality of flakes to orient at least a portion of the flakes to cause the easy axes thereof to be substantially aligned with the first magnetic field;
joining the first plurality of flakes together to create the yoke;
repeating the following steps until the teeth and the stator core is complete:
positioning an additional plurality of flakes within the yoke to form the shape least one of the teeth, at least a portion of the additional plurality of flakes being magnetically anisotropic and having an easy axis;
applying a second magnetic field to the additional plurality of flakes to orient at least a portion of the flakes to cause the easy axes thereof to be substantially aligned with the second magnetic field; and
joining the additional plurality of flakes together to create at least one of the teeth attached to the yoke;
wherein the first and second magnetic fields have different magnetic field orientations; and
wherein the first and the additional pluralities of flakes are significantly surrounded by an insulating material.

12. The method of claim 11, further comprising compressing the completed stator core along axial directions of the stator core.

13. The method of claim 11, wherein applying the first magnetic field to the first plurality of flakes to orient at least a portion of the flakes causes the easy axes thereof to be directed substantially circumferentially about a central longitudinal axis of the yoke.

14. The method of claim 11, wherein applying the second magnetic field to the additional plurality of flakes to orient at least a portion of the flakes causes the easy axes thereof to be directed substantially radially with respect to a central longitudinal axis of the yoke.

15. The method of claim 11, wherein the first and the additional pluralities of flakes are significantly surrounded by the insulating material by coating the first and the additional pluralities of flakes with the insulating material.

16. The method of claim 11, further comprising positioning a first portion of the insulating material to partially form the shape of the yoke; wherein positioning the first plurality of flakes to form the shape of the yoke further comprises submerging the first plurality of flakes within the first portion of the insulating material.

17. The method of claim 14, further comprising positioning an additional portion of the insulating material to partially form the shape of at least one of the teeth; wherein positioning the additional plurality of flakes to form the shape of at least one of the teeth further comprises submerging the additional plurality of flakes within the additional portion of the insulating material.

18. The method of claim 11, wherein joining the first plurality of flakes together comprises at least one of heat treating the flakes, applying a conditioning force to flakes, heat treating the insulating material that is significantly surrounding the flakes, applying a conditioning force to the insulating material that is significantly surrounding the flakes, and curing the insulating material that is significantly surrounding the flakes; and wherein joining the second plurality of flakes together comprises at least one of heat treating the flakes, applying a conditioning force to the flakes, heat treating the insulating material that is significantly surrounding the flakes, applying a conditioning force to the insulating material that is significantly surrounding the flakes, and curing the insulating material that is significantly surrounding the flakes.

19. A stator core comprising:
a yoke having an interior cavity extending therethrough about a central longitudinal axis of the yoke; and
teeth positioned within the interior cavity and connected to the yoke, the teeth substantially oriented extending towards the central longitudinal axis of the yoke;
wherein the yoke and the teeth comprise a plurality of flakes that are coated by an insulating material;
wherein at least a portion of the plurality of flakes are magnetically anisotropic and include an easy axis;
wherein the easy axes of at least a portion of the plurality of flakes of the yoke are substantially directed along a first orientation; and
wherein the easy axes of at least a portion of the plurality of flakes of the teeth are substantially directed along a second orientation that is different than the first orientation.

20. The stator core of claim 19, wherein at least a portion of the plurality of flakes comprise anisotropic high silicon steel (HSS).

21. The stator core of claim 19, wherein the first orientation is directed substantially circumferentially about the central longitudinal axis of the yoke.

22. The stator core of claim 19, wherein the second orientation is directed substantially radially with respect to the central longitudinal axis of the yoke.
